(19) United States
(12) Patent Application Publication
(10) Pub. No.: US 2016/0167527 A1
(43) Pub. Date: Jun. 16, 2016

(54) METHOD FOR CONTROLLING BRAKING FORCE IN REGENERATIVE BRAKE COOPERATION CONTROL

(71) Applicant: Hyundai Motor Company, Seoul (KR)

(72) Inventors: Gab Bae JEON, Hwaseong-si (KR); Joung Hee LEE, Suwon-si (KR); Sang Hyun SHIM, Seoul (KR); Jae Hun SHIM, Hwaseong-si (KR)

(73) Assignee: Hyundai Motor Company, Seoul (KR)

(21) Appl. No.: 14/931,726

(22) Filed: Nov. 3, 2015

(30) Foreign Application Priority Data
Dec. 12, 2014 (KR) 10-2014-0179543

(51) Int. Cl. B60L 7/26

(52) U.S. Cl. CPC B60L 7/26

(57) ABSTRACT

A method for controlling a braking force in regenerative brake cooperation control, may include a first step of generating a regenerative braking force for at least one of a front wheel and a rear wheel up to a reference deceleration while braking, and a second step of distributing the braking force of the front wheel and the rear wheel in accordance with a reference braking distribution ratio having a predetermined value in a braking area of the reference deceleration or more.

### CROSS-REFERENCE TO RELATED APPLICATION

The present application claims priority to Korean Patent Application No. 10-2014-0179543 filed on Dec. 12, 2014, the entire contents of which is incorporated herein for all purposes by this reference.

### BACKGROUND OF THE INVENTION

1. Field of the Invention

The present invention relates to a method for controlling braking force in regenerative brake cooperation control, and more particularly, to a method for controlling braking force in regenerative brake cooperation control in an environmental vehicle performing regenerative braking at front wheel and/or a rear wheel.

2. Description of Related Art

In environmental vehicles (a hybrid vehicle, an electric vehicle, a fuel cell vehicle, and the like) that perform regenerative braking at both a front wheel and a rear wheel, a regenerative brake cooperation control is different from that in vehicles that perform the regenerative braking only at the front wheel in the related art.

A drive motor is disposed at the front wheel in the environmental vehicles (the hybrid vehicle, the electric vehicle, the fuel cell vehicle, and the like) that perform only front regenerative braking.

When energy is recovered by charging a battery in the drive motor, regenerative braking force is generated and the braking force acts on only the front wheel.

Since a possibility that a spin of a vehicle will occur is low in spite of large total braking force of the front wheel by the regenerative force of the front wheel, a generation amount of the regenerative braking force may be maximized as possible so as to maximally generate the energy. In addition, a system for cooperation control of hydraulic braking force is also configured by considering only the regenerative braking force of the front wheel.

When the regenerative braking may be performed at both the front wheel and the rear wheel, the regenerative braking force is applied even to the rear wheel, and as a result, when the regenerative braking force of the rear wheel increases to recover more energy, the spin occurrence possibility increases as the rear wheel is locked, there is a limit in increasing the regenerative braking force like a front-wheel regenerative braking vehicle.

FIG. 1 illustrates distribution of braking force of the front-wheel regenerative braking vehicle as described above. FIG. 2 illustrates actual front and rear wheel braking force distribution in a relationship with an ideal braking force distribution curve in the front-wheel regenerative braking vehicle.

As illustrated in FIG. 1, when braking force equal to or more than the front-wheel regenerative braking force is required, the same hydraulic pressure is applied to wheel brakes of the front wheel and the rear wheel to generate hydraulic braking force.

In the case of the front-wheel regenerative braking, although the braking force distribution is provided, since deceleration in which rear wheel lock may first occur is higher than that in a vehicle adopting a general hydraulic brake, safety of the vehicle is not significantly damaged, as illustrated in FIG. 2.

That is, referring to an actual braking distribution line, since only the front-wheel regenerative braking force is generated up to a maximum value of the front-wheel regenerative braking force and thereafter, the braking force of the front and rear wheels by the hydraulic brake is generated, a cross point with the ideal braking distribution line is relatively large moves to a relatively large deceleration region.

The magnitude of the regenerative braking force generated in the front wheel is proportional to a capacity of the drive motor and a deceleration in which the front wheel lock may first occur also varies depending on the capacity of the drive motor.

Accordingly, since the environmental vehicles performing only the front-wheel regenerative braking has no problem in stability of the vehicle even though the braking force of the front wheel is increased by the front-wheel regenerative braking force, a braking force ratio between the front and rear-wheel hydraulic brakes may not be changed and as a pipe of a brake system, an X-Split pipe similarly generating the front and rear-wheel hydraulic pressures may be used.

On the contrary, when the brake system and the braking force distribution in the related art are performed with respect to the environmental vehicles performing the regenerative braking at the rear wheel or the front and rear wheel, a braking line diagram representing the braking force distribution and actual power distribution are illustrated in FIGS. 3 and 4.

As illustrated in FIGS. 3 and 4, when the brake system and the braking force distribution in the related art are used in the environmental vehicles performing the regenerative braking at the rear wheel or the front and rear wheels, the regenerative braking force of the front wheel is first used to increase an energy recovery amount and when the braking force equal to or more than the rear-wheel regenerative braking force is required (in deceleration equal to or more than “A”), the same hydraulic pressure is applied to the front and rear wheel brakes to generate the hydraulic braking force.

In this case, when the regenerative braking force is maximally used to recover the energy, the deceleration in which the rear lock may first occur decreases to degrade the stability of the vehicle and when a regenerative braking amount is limited to secure the stability of the vehicle, the energy recovery amount decreases.

Therefore, a regenerative braking cooperation control method that may enhance fuel efficiency by maximizing the regenerative braking in addition to the vehicle stability and braking performance is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for controlling braking force in a regenerative brake cooperation system which adopts a brake system independently controlling braking force of a front wheel and a rear wheel in environmental vehicles performing regenerative braking at the front wheel and/or the rear wheel, in which the brake system can secure stability of a vehicle and improve fuel efficiency, and distributes braking force so as to guarantee excellent performance in terms of braking performance.

In one aspect, the present invention provides a method for controlling braking force in regenerative brake cooperation control including: a first step of generating regenerative braking force for at least one of a front wheel and a rear wheel up to a reference deceleration while braking; and a second step of distributing the braking force of the front wheel and the rear wheel in accordance with a reference braking distribution ratio having a predetermined value in a braking area of the reference deceleration or more.

In an exemplary embodiment, in the first step, the braking force of the front wheel and the rear wheel may be distributed in accordance with an ideal braking distribution line.

In another exemplary embodiment, in the first step, the braking force distributed to the rear wheel may be controlled to be generated only by the rear-wheel regenerative braking force up to maximum rear-wheel regenerative braking force.

In still another exemplary embodiment, the reference braking distribution ratio in the second step may be set similarly to a braking distribution ratio of a basic braking distribution line.

In yet another exemplary embodiment, in the first step, the braking force of the front wheel and the rear wheel may be configured to be distributed in accordance with the basic braking distribution line.

In still yet another exemplary embodiment, in the first step, the braking force distributed to the front wheel may be controlled to be generated only by the front-wheel regenerative braking force up to the maximum front-wheel regenerative braking force and the braking force distributed to the rear wheel may be controlled to be generated only by the rear-wheel regenerative braking force.

In a further exemplary embodiment, the reference braking distribution ratio in the second step may be set similarly to the braking distribution ratio of the basic braking distribution line.

In another further exemplary embodiment, in the first step, the braking force distributed to the front wheel may be controlled to be generated by front-wheel hydraulic braking force and the braking force distributed to the rear wheel may be controlled to be generated only by the rear-wheel regenerative braking force up to the maximum rear-wheel regenerative braking force.

In still another exemplary embodiment, in the first step, the braking force of the front wheel and the rear wheel may be distributed in accordance with a ratio between the maximum front-wheel regenerative braking force and the maximum rear-wheel regenerative braking force.

In yet another further exemplary embodiment, in the first step, the braking force distributed to the front wheel may be controlled to be generated only by the front-wheel regenerative braking force up to the maximum front-wheel regenerative braking force and the braking force distributed to the rear wheel may be controlled to be generated only by the rear-wheel regenerative braking force.

In still yet another further exemplary embodiment, in the first step, front-wheel regenerative braking force may be maximally generated and thereafter, rear-wheel braking force may be controlled to increase so as to distribute the braking force of the front wheel and the rear wheel in accordance with the basic braking distribution line.

In a still further exemplary embodiment, in the first step, when the rear-wheel braking force increases to achieve the braking force distribution ratio of the front wheel and the rear wheel in accordance with the basic braking distribution line, the first step may be controlled to end and the second step may be controlled to be entered.

In another still further embodiment, in the first step, when the rear-wheel braking force increases to have the braking force distribution ratio of the front wheel and the rear wheel in accordance with the basic braking distribution line, up to a point where an ideal braking distribution line and the basic distribution line cross, the braking force of the front wheel and the rear wheel may be controlled to be distributed in accordance with the ideal braking distribution line and from the point where an ideal braking distribution line and the basic distribution line cross, the braking force of the front wheel and the rear wheel may be controlled to be distributed at a predetermined ratio in accordance with the basic braking distribution line according to the second step.

In still another still further exemplary embodiment, in the first step, the rear-wheel regenerative braking force may be maximally generated and thereafter, only the front-wheel braking force may be controlled to increase so as to distribute the braking force of the front wheel and the rear wheel in accordance with the basic braking distribution line.

In still yet another still further exemplary embodiment, in the first step, when the front-wheel braking force increases to achieve the braking force distribution ratio of the front wheel and the rear wheel in accordance with the basic braking distribution line, the first step may be controlled to end and the second step may be controlled to be entered.

In still yet another still further embodiment, in the first step, when the front-wheel braking force increases to have the braking force distribution ratio of the front wheel and the rear wheel in accordance with the basic braking distribution line, up to the point where the ideal braking distribution line and the basic distribution line cross, the braking force of the front wheel and the rear wheel may be controlled to be distributed in accordance with the ideal braking distribution line and from the point where the ideal braking distribution line and the basic distribution line cross, the braking force of the front wheel and the rear wheel may be controlled to be distributed at a predetermined ratio in accordance with the basic braking distribution line according to the second step.

In still yet another still further embodiment, in the first step, only when the maximum rear-wheel regenerative braking force is larger than the maximum front-wheel regenerative braking force, the braking force of the front wheel and the rear wheel may be distributed until the maximum braking force of the front wheel and the rear wheel is generated in accordance with a ratio between the maximum rear-wheel regenerative braking force and the maximum front-wheel regenerative braking force and only the front-wheel hydraulic braking force may be controlled to increase so as to distribute the braking force of the front wheel and the rear wheel in accordance with the basic braking distribution line.

In still yet another still further embodiment, in the first step, only when the maximum front-wheel regenerative braking force is larger than the maximum rear-wheel regenerative braking force, the braking force of the front wheel and the rear wheel may be distributed until the maximum braking force of the front wheel and the rear wheel is generated in accordance with a ratio between the maximum rear-wheel regenerative braking force and the maximum front-wheel regenerative braking force and only the rear-wheel hydraulic braking force may be controlled to increase so as to distribute the braking force of the front wheel and the rear wheel in accordance with the basic braking distribution line.

In still yet another still further embodiment, in the first step, the rear-wheel regenerative braking force may be maximally generated and thereafter, only the rear-wheel regenerative braking force may be generated up to a rear-wheel regenerative braking limit value and only the front-wheel braking force may be controlled to increase so as to distribute the braking force of the front wheel and the rear wheel in accordance with the basic braking distribution line.

In still yet another still further embodiment, when the front-wheel braking force increases up to the point where the ideal braking distribution line and the basic braking distribution line cross, the first step may end and the second step may be entered, in which in the second step, the hydraulic braking force of the front wheel and the rear wheel may be generated at a ratio depending on the basic braking distribution line.

In still yet another still further embodiment, when the front-wheel braking force increases up to the point where the ideal braking distribution line and the basic braking distribution line cross, the first step may end and the second step may be entered, in which in the second step, the rear-wheel regenerative braking force may be maximally generated in accordance with the basic braking distribution line and thereafter, the rear-wheel hydraulic braking force may be generated.

In a method for controlling braking force in regenerative brake cooperation control according to the present invention, separating and controlling braking force at a front wheel and a rear wheel is adopted in environmental vehicles performing regenerative braking at the front wheel and/or the rear wheel, however, the braking force at the front wheel and the rear wheel can be distributed and the regenerative braking force can be generated so as to shorten a road surface friction coefficient range in which the rear wheel is first locked.

As a result, in an implementation example of the present invention, stability of a vehicle is secured by preventing turning of the vehicle due to rear-wheel lock while braking and ABS operability is decreased to enhance deterioration of durability by a frequent operation of an ABS and a sense of difference felt by a driver.

Further, according to the present invention, regenerative energy recovery rate can be maximized in a range to significantly secure the stability and braking force of the vehicle to improve fuel efficiency of the vehicle.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 illustrate braking line diagrams for distribution of braking force of a vehicle performing only front-wheel regenerative braking;

FIGS. 3 and 4 are braking line diagrams illustrating distribution of braking force when rear-wheel regenerative braking force is preferentially generated in a vehicle performing regenerative braking at a rear wheel or front and rear wheels;

FIG. 5 schematically illustrates a configuration of a brake system adopted in a exemplary implementation example of the present invention; and

FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, and FIG. 23 are braking line diagrams illustrating distribution of front and rear-wheel braking force and regenerative braking force in a method for controlling braking force in regenerative brake cooperation control according to a exemplary implementation example of the present invention.

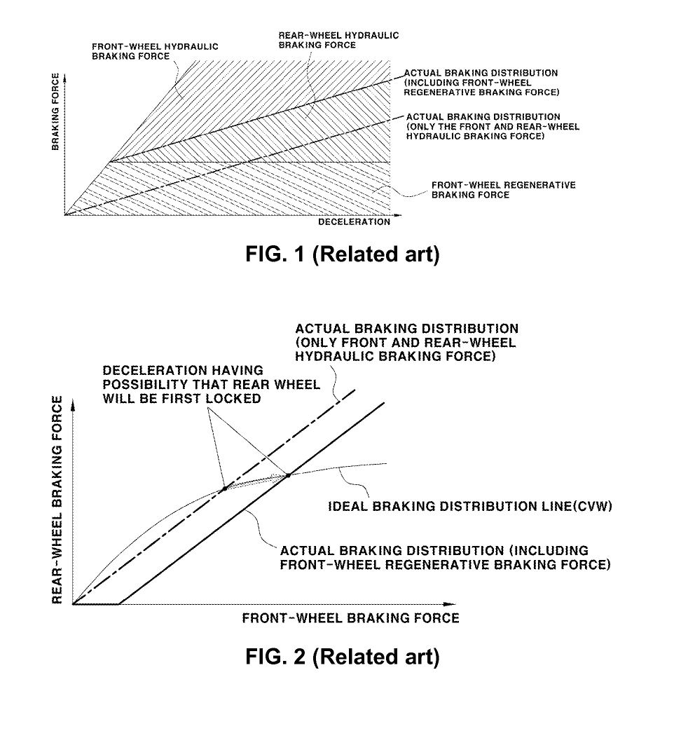

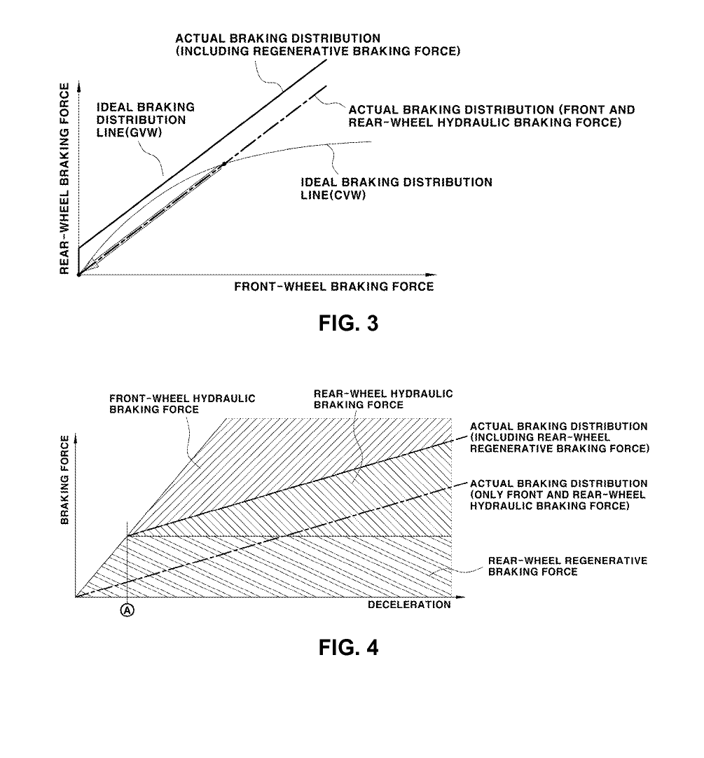

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a method for controlling braking force in new type of regenerative brake cooperation control, which can satisfy all characteristics of improvement of vehicle stability, braking performance, and fuel efficiency in environmental vehicles (a hybrid vehicle, an electric vehicle, a fuel cell vehicle, and the like) performing regenerative braking force at a front wheel, a rear wheel, or both the front wheel and the rear wheel.

To this end, in the specification, a basic brake system for implementing the method for controlling braking force in the regenerative brake cooperation control will be schematically described. Further, based on the brake system, a method for controlling braking force in regenerative brake cooperation control, which includes a braking force distributing scheme of appropriately distributing regenerative braking force and hydraulic braking force of the front wheel and the rear wheel will be described based on the brake system.

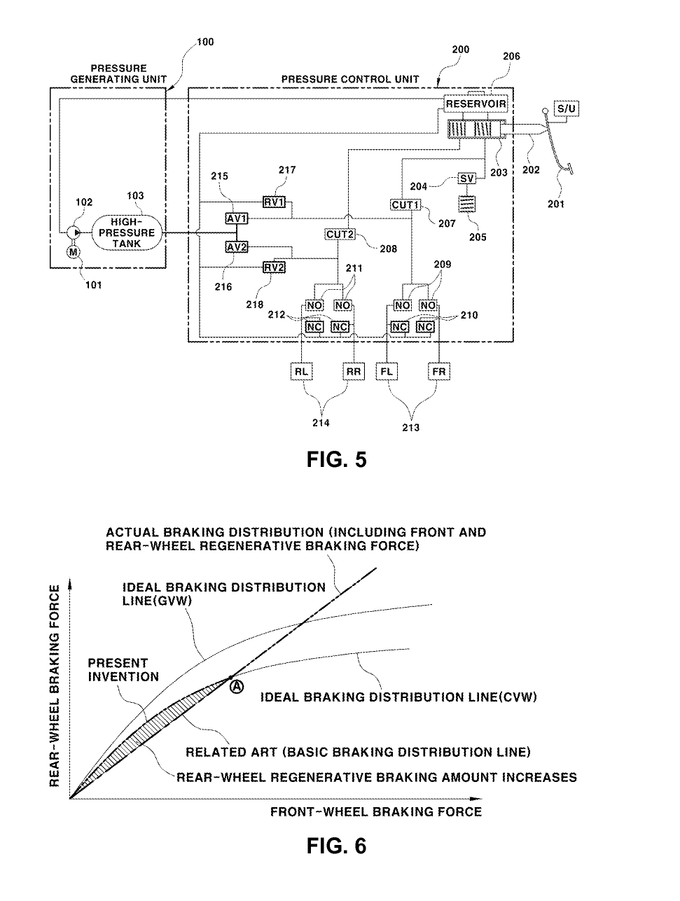

In this regard, in the present specification, a brake system having a form represented in FIG. 5 is exemplified, but the brake system is introduced as one example of a system which can independently control braking force of the front wheel and the rear wheel and the method for controlling braking force in regenerative brake cooperation control according to an exemplary embodiment of the present invention is not particularly applied to only the brake system.

For example, an electro mechanical brake (EMB) system which can independently control braking force of four wheels may also be included.

Further, in the present specification, implementation examples of the method for controlling braking force in regenerative brake cooperation control according to an exemplary embodiment of the present invention are described, but inventions disclosed in the claims should not be limitatively analyzed by the implementation examples and should be analyzed to include various implementation examples contrived by the gist of the present invention.

Hereinafter, the method for controlling braking force in regenerative brake cooperation control according to an exemplary embodiment of the present invention will be described in detail with reference to the accompanying drawings.

FIG. 5 schematically illustrates a configuration of a regenerative brake system for an H-Split pipe which may be adopted in an exemplary implementation example of the present invention.

In the method for controlling braking force in regenerative brake cooperation control according to the exemplary implementation example of the present invention, independent control of braking force of a front wheel and a rear wheel is requested. Therefore, as illustrated in FIG. 5, a system that may independently control hydraulic pressure of the front wheel and the rear wheel is required.

The system is configured to include a pressure generating unit 100 including a motor 101 and a pump 102 and a high-pressure tank 103 and a pressure controller 200 configured to control the braking force of each wheel by controlling pressure generated by the pressure generating unit 100.

When a brake pedal 201 applies pressure to a master cylinder 203 through a push rod 202, the system receives information on a stroke unit to open a simulator valve 204 and closes cut valves 207 and 208.

When a pedal is more deeply stepped, reaction force of the pedal is generated by an elastic member such as a spring in a pedal simulator 205.

Front-wheel target pressure corresponding to a pedal stroke moves a flow at the pressure tank side to a pipe at a front wheel side by opening a first apply valve 215 to generate pressure.

Further, rear-wheel target pressure corresponding to the pedal stroke moves the flow at the pressure tank side to a pipe at a rear wheel side by opening a second apply valve 216 to generate pressure.

The pressure that moves to the pipe at the front wheel side or the rear wheel side through the first and second apply valves is configured to form the hydraulic pressure at the respective wheel sides by normally open valves 209 and 211 formed at the respective front wheels.

Meanwhile, when the pressure in the pipe intends to be decreased or the hydraulic pressure intends to be released, the flow is discharged by opening a first release valve 217 or a second release valve 218 to depressurize or release the pressure.

Undescribed normally closed valves 210 and 212 are connected to a reservoir 206 side.

Therefore, the regenerative brake for the H-Split pipe illustrated in FIG. 5 appropriately controls a pair of apply valves and another pair of release valves to independently control the hydraulic pressure of the front wheel and the rear wheel.

The brake system is used by distributing drive forces of the front wheel and the rear wheel according to a braking line diagram set to maximize the regenerative braking force within a range to suppress rear-wheel lock from first occurring.

Accordingly, according to the exemplary implementation example of the present invention, the method includes a step of setting a reference deceleration, distributing the braking force of the front wheel and the rear with inclusion of the regenerating braking force for at least one of the front wheel and the rear wheel up to a reference deceleration point, and increasing the regenerative braking force.

Further, the method includes a step of distributing the braking force of the front wheel and the rear wheel at a predetermined ratio according to a reference braking distribution ratio of a predetermined value in an area equal to or more than the reference deceleration, and as a result, the braking force may be sufficiently secured under a situation in which a vehicle weight increases.

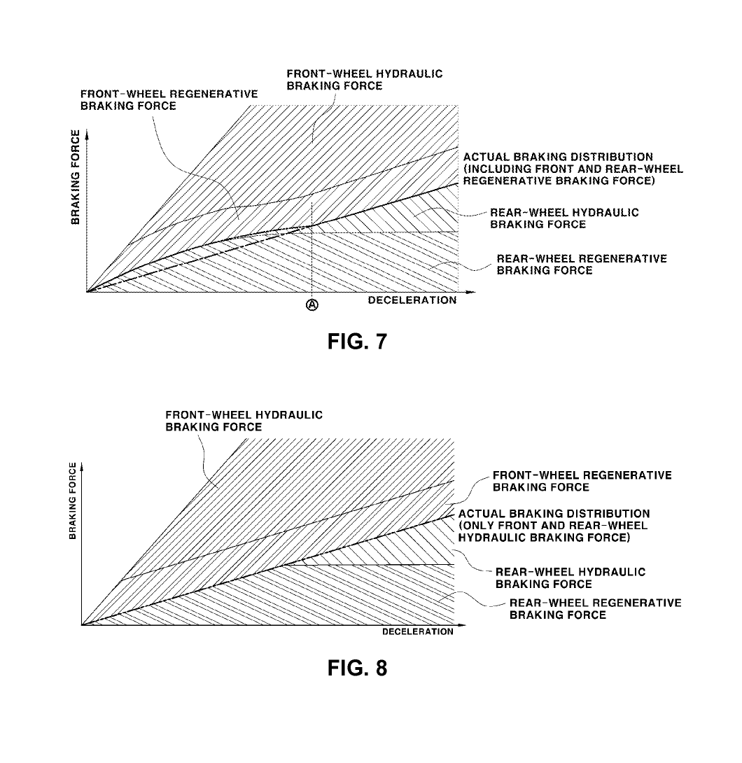

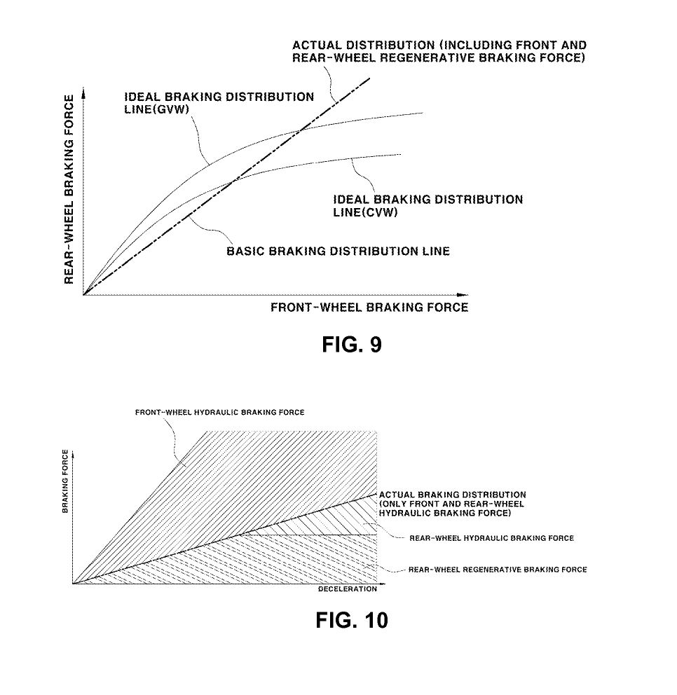

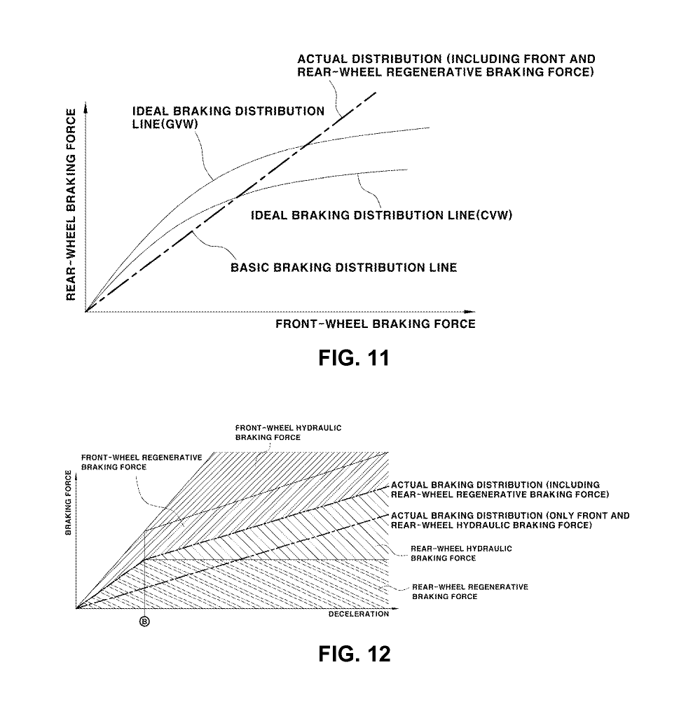

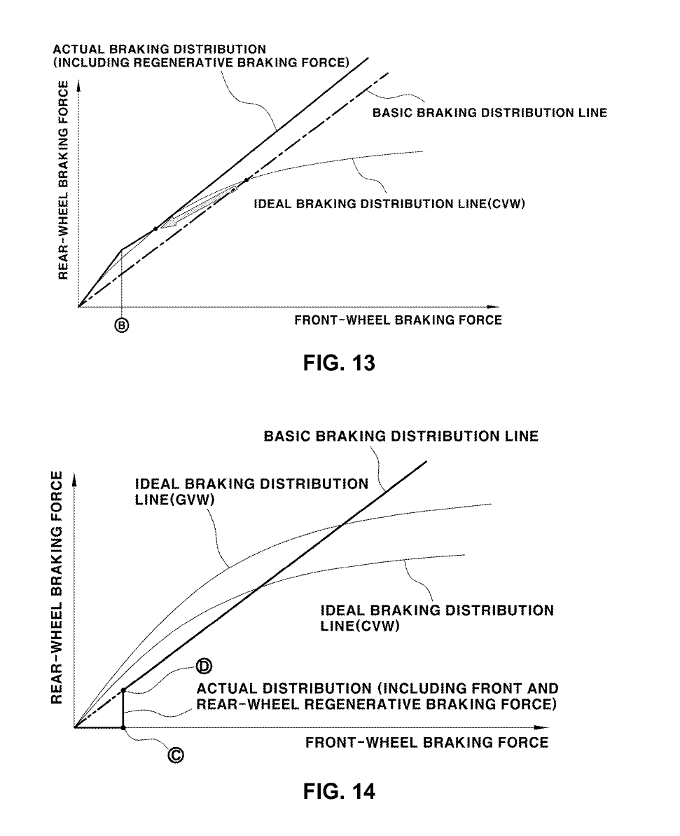

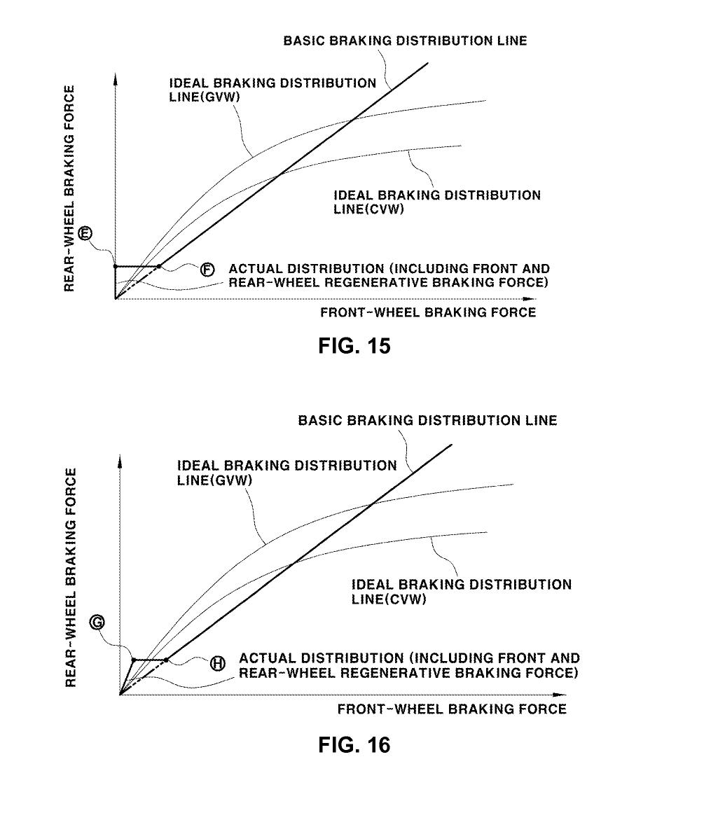

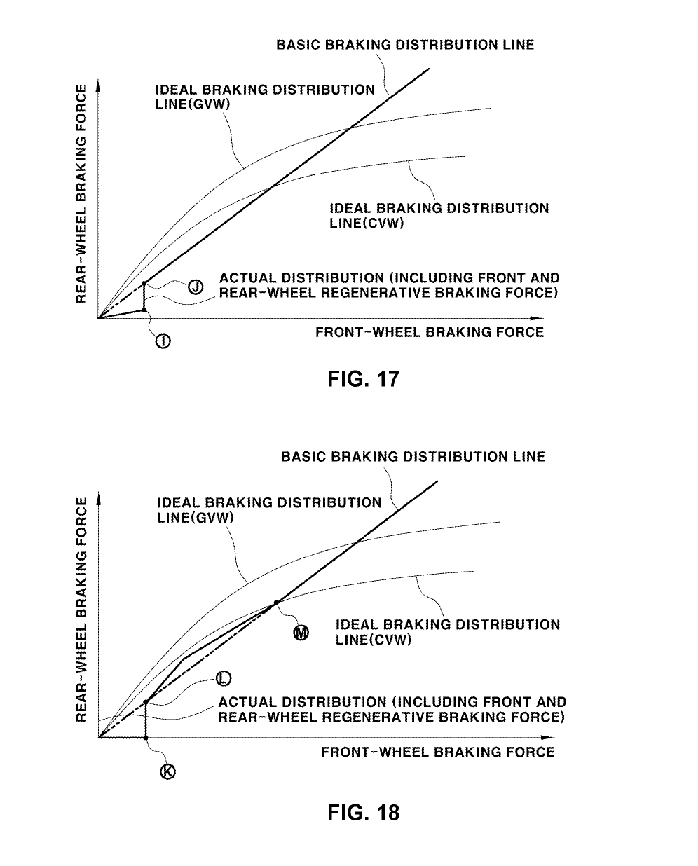

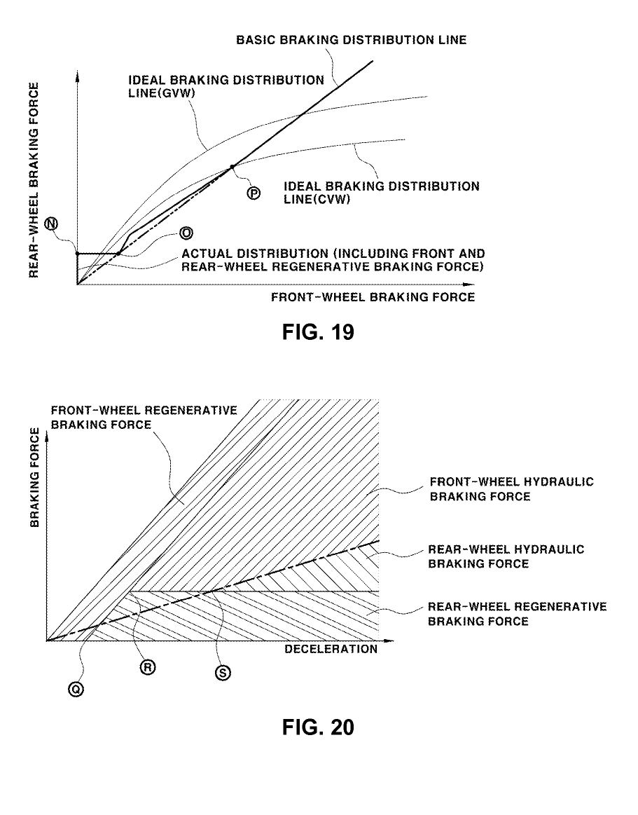

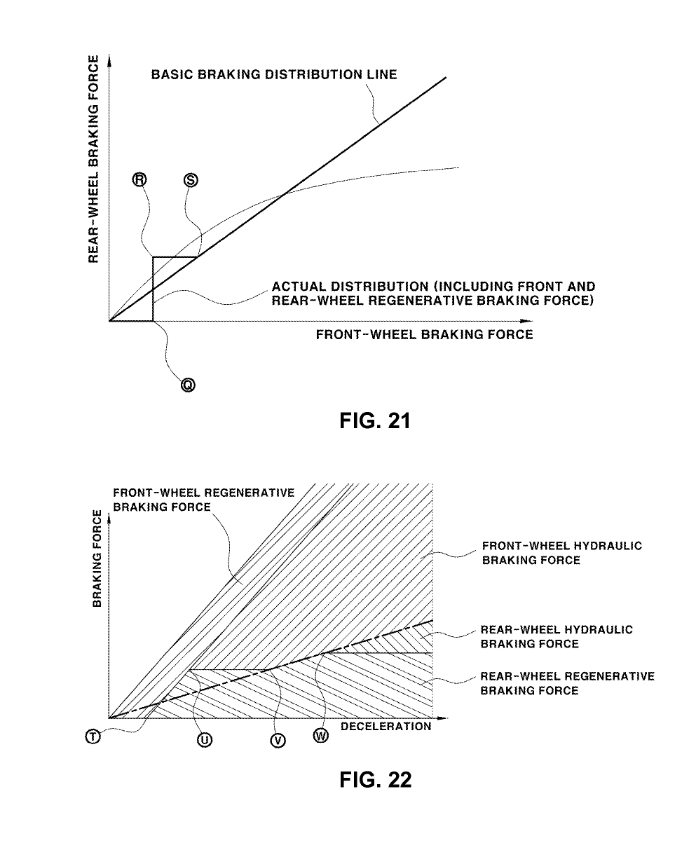

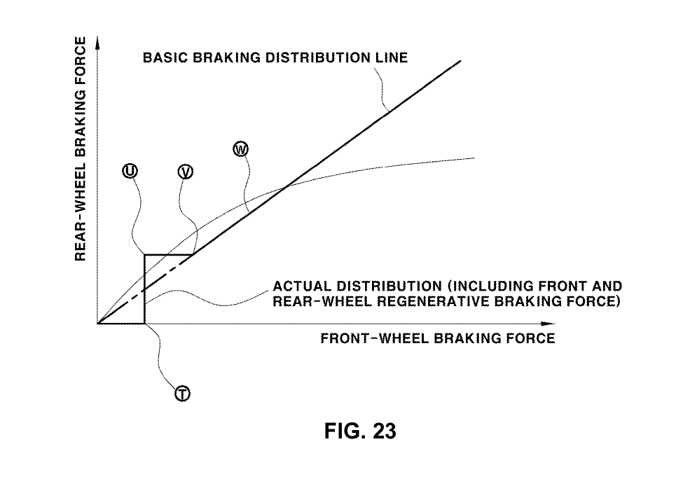

In this regard, FIGS. 6 to 23 as braking line diagrams for the exemplary implementation examples of the present invention using the brake system illustrate, in detail, a distribution relationship of front and rear-wheel braking force and regenerative braking force.

First, FIG. 6 illustrates an example of distributing the braking force based on an ideal braking distribution line of a complete vehicle weight (CVW) before point A and determining the distribution of the braking force based on distribution represented by front-wheel and rear-wheel brake specifications after point A, based on a reference deceleration point (point A).

Preferably, the reference deceleration point (point A) is a point where the ideal braking distribution line and the braking distribution line based on the distribution represented by the front-wheel and rear-wheel brake specifications cross.

In this case, a linearized braking force distribution line of FIG. 6 is a straight line having a predetermined ratio determined by a distribution ratio depending on the front-wheel and rear-wheel brake specifications.

Accordingly, when a braking distribution ratio of the front wheel and the rear wheel after point A is referred to as a reference braking distribution ratio, the reference braking distribution ratio may be a braking ratio of a basic braking distribution line in the related art and distributed at an appropriate braking ratio by considering a design element.

As illustrated in FIG. 6, in the implement example of distributing the braking force, since the braking force is distributed according to the ideal braking distribution line in a section before point A (expressed by ‘present art’ on a graph), the ideal braking distribution line shows a difference from the basic braking distribution line (expressed by ‘related art’ on the graph).

That is, the actual braking distribution line according to the present implementation example shows the same form as the hydraulic braking distribution line after point A, but set to follow the ideal braking distribution line before point A, and as a result, the rear-wheel regenerative braking force may be relatively further used like an area marked by an oblique line. Accordingly, since the regenerative braking amount may be increased, recoverable energy is increased.

Further, the braking force is distributed to have a predetermined distribution ratio between the front wheel and the rear wheel like the linearized form of FIG. 6 in a section after point A and the braking force may be sufficiently secured under the situation in which the vehicle weight increases.

FIG. 7 illustrates distribution of total braking force including regenerative braking force of the front wheel and the rear wheel in the implementation example depending on FIG. 6.

As illustrated in FIG. 6, when maximum front-wheel regenerative braking force is generated, front-wheel hydraulic braking force increases. Further, after point A, braking distribution of the front and rear wheels is performed at a predetermined ratio.

When the rear-wheel regenerative braking force is provided, the braking force of the front wheel may be generated only by hydraulic friction braking force instead of the front-wheel regenerative braking force.

In the implementation example, since front-wheel target pressure and rear-wheel target pressure are determined according to the braking force distribution and the regenerative braking amount of the front wheel and the rear wheel, the front-wheel target pressure and the rear-wheel target pressure may not be the same pressure.

Moreover, as described above, the same scheme as the present implementation example may be applied to the brake system that may independently control the braking force of the front wheel and the rear wheel like a 4-wheel EMB system.

FIGS. 8 and 9 illustrate braking line diagrams in a method for controlling braking force in regenerative brake cooperation control according to yet another implementation example of the present invention.

In the implementation example, the braking force of the front and rear wheels is applied similarly to the front-rear braking force ratio by the existing hydraulic braking force. Further, like FIG. 8, the regenerative braking force is generated up to a deceleration which may be generated by a front-wheel regenerative brake in the front-wheel braking force and the regenerative braking force is generated up to the deceleration which may be generated by the rear-wheel regenerative brake in a rear-wheel braking force.

Such a method may secure vehicle stability at the same level as the existing hydraulic brake system.

FIGS. 10 and 11 illustrate braking line diagrams in a method for controlling braking force in regenerative brake cooperation control according to yet another implementation example of the present invention.

The present implementation example is a braking force distribution method for a vehicle in which only the rear-wheel regenerative braking is possible. That is, the braking force of the front and rear wheels is used similarly to the front-rear braking force ratio by the existing hydraulic braking force and the regenerative braking force is generated up to the deceleration which may be generated by the rear-wheel regenerative brake in the rear-wheel braking force.

Such a method may also secure vehicle stability at the same level as the existing hydraulic brake system.

FIGS. 12 and 13 illustrate braking line diagrams in a method for controlling braking force in regenerative brake cooperation control according to yet another implementation example of the present invention.

In the present implementation example, braking is performed only by the front-wheel and rear-wheel regenerative braking force up to a deceleration at a level of point B. In this case, a ratio of the front and rear-wheel regenerative braking force is determined by maximum regenerative braking force output from each of the front wheel and the rear wheel. That is, for example, when a ratio in output maximum regenerative braking force between the front wheel and the rear wheel is 1:2, the braking force of the front wheel and the rear wheel is distributed at the same ratio.

Therefore, up to point B, each of the front wheel and the rear wheel generates the maximum regenerative braking force and in the deceleration area at the level of B point or more, the hydraulic pressure of the front and rear wheels are similarly generated like the front-wheel regenerative brake system.

Referring to FIG. 13, the actual braking distribution line according to the implementation example is positioned relatively above the hydraulic braking distribution line marked with dotted lines and generates the total maximum regenerative braking force in the area before point B.

Since such a method may maximize the regenerative braking amount, a fuel efficiency improvement effect may be increased.

FIGS. 8 to 9 are braking line diagrams illustrating distribution of front and rear-wheel braking force and regenerative braking force in a method for controlling braking force in regenerative brake cooperation control according to an exemplary implementation example of the present invention.

In the implementation example, the braking force of the front and rear wheels is applied similarly to the front-rear braking force ratio by the existing hydraulic braking force. Further, like FIG. 8, the regenerative braking force is generated up to a deceleration which may be generated by a front-wheel regenerative brake in the front-wheel braking force and the regenerative braking force is generated up to the deceleration which may be generated by the rear-wheel regenerative brake in a rear-wheel braking force.

Such a method may secure vehicle stability at the same level as the existing hydraulic brake system.

FIGS. 10 and 11 illustrate braking line diagrams in a method for controlling braking force in regenerative brake cooperation control according to yet another implementation example of the present invention.

The present implementation example is a braking force distribution method for a vehicle in which only the rear-wheel regenerative braking is possible. That is, the braking force of the front and rear wheels is used similarly to the front-rear braking force ratio by the existing hydraulic braking force and the regenerative braking force is generated up to the deceleration which may be generated by the rear-wheel regenerative brake in the rear-wheel braking force.

Such a method may also secure vehicle stability at the same level as the existing hydraulic brake system.

FIGS. 12 and 13 illustrate braking line diagrams in a method for controlling braking force in regenerative brake cooperation control according to yet another implementation example of the present invention.

In the present implementation example, braking is performed only by the front-wheel and rear-wheel regenerative braking force up to a deceleration at a level of point B. In this case, a ratio of the front and rear-wheel regenerative braking force is determined by maximum regenerative braking force output from each of the front wheel and the rear wheel. That is, for example, when a ratio in output maximum regenerative braking force between the front wheel and the rear wheel is 1:2, the braking force of the front wheel and the rear wheel is distributed at the same ratio.

Therefore, up to point B, each of the front wheel and the rear wheel generates the maximum regenerative braking force and in the deceleration area at the level of B point or more, the hydraulic pressure of the front and rear wheels are similarly generated like the front-wheel regenerative brake system.

Referring to FIG. 13, the actual braking distribution line according to the implementation example is positioned relatively above the hydraulic braking distribution line marked with dotted lines and generates the total maximum regenerative braking force in the area before point B.

Since such a method may maximize the regenerative braking amount, a fuel efficiency improvement effect may be increased.

FIGS. 8 to 9 are braking line diagrams illustrating distribution of front and rear-wheel braking force and regenerative braking force in a method for controlling braking force in regenerative brake cooperation control according to an exemplary implementation example of the present invention.

In the implementation example, the braking force of the front and rear wheels is applied similarly to the front-rear braking force ratio by the existing hydraulic braking force. Further, like FIG. 8, the regenerative braking force is generated up to a deceleration which may be generated by a front-wheel regenerative brake in the front-wheel braking force and the regenerative braking force is generated up to the deceleration which may be generated by the rear-wheel regenerative brake in a rear-wheel braking force.

Such a method may secure vehicle stability at the same level as the existing hydraulic brake system.

FIGS. 10 to 11 are braking line diagrams illustrating distribution of front and rear-wheel braking force and regenerative braking force in a method for controlling braking force in regenerative brake cooperation control according to an exemplary implementation example of the present invention.

The present implementation example is a braking force distribution method for a vehicle in which only the rear-wheel regenerative braking is possible. That is, the braking force of the front and rear wheels is used similarly to the front-rear braking force ratio by the existing hydraulic braking force and the regenerative braking force is generated up to the deceleration which may be generated by the rear-wheel regenerative brake in the rear-wheel braking force.

Such a method may also secure vehicle stability at the same level as the existing hydraulic brake system.

FIGS. 12 to 13 are braking line diagrams illustrating distribution of front and rear-wheel braking force and regenerative braking force in a method for controlling braking force in regenerative brake cooperation control according to an exemplary implementation example of the present invention.

In the present implementation example, braking is performed only by the front-wheel and rear-wheel regenerative braking force up to a deceleration at a level of point B. In this case, a ratio of the front and rear-wheel regenerative braking force is determined by maximum regenerative braking force output from each of the front wheel and the rear wheel. That is, for example, when a ratio in output maximum regenerative braking force between the front wheel and the rear wheel is 1:2, the braking force of the front wheel and the rear wheel is distributed at the same ratio.

Therefore, up to point B, each of the front wheel and the rear wheel generates the maximum regenerative braking force and in the deceleration area at the level of B point or more, the hydraulic pressure of the front and rear wheels are similarly generated like the front-wheel regenerative brake system.

Referring to FIG. 13, the actual braking distribution line according to the implementation example is positioned relatively above the hydraulic braking distribution line marked with dotted lines and generates the total maximum regenerative braking force in the area before point B.

Since such a method may maximize the regenerative braking amount, a fuel efficiency improvement effect may be increased.

FIG. 14 illustrates a braking line diagram in a method for controlling braking force in regenerative brake cooperation control according to yet another implementation example of the present invention.

As illustrated in FIG. 14, in the implementation example, front-wheel regenerative braking force is maximally generated up to a point C, and thereafter, rear wheel braking force is increased until front wheel/rear wheel braking distribution is the same as actual braking distribution (up to a point D).

After the front wheel/rear wheel braking distribution is the same as a basic braking distribution line, front wheel/rear wheel braking forces are simultaneously increased with the same distribution as the basic braking distribution line.

FIG. 15 illustrates a braking line diagram in a method for controlling braking force in regenerative brake cooperation control according to still another implementation example of the present invention.

In the implementation example of FIG. 15, unlike the implementation example of FIG. 14, the rear-wheel regenerative braking force is first generated.

That is, as illustrated in FIG. 15, the rear-wheel regenerative braking force is maximally generated up to a point E, and thereafter, front wheel braking force is increased until front wheel/rear wheel braking distribution is the same as actual braking distribution (up to a point F).

After the front wheel/rear wheel braking force distribution is the same as a basic braking distribution line, front wheel/rear wheel braking forces are simultaneously increased with the same distribution as the actual braking distribution.

FIGS. 16 to 17 illustrate braking line diagrams in a method for controlling braking force in regenerative brake cooperation control according to still yet another implementation example of the present invention, and in the implementation examples, an example in which there is a difference between front wheel maximum regenerative braking force and rear wheel maximum regenerative braking force is illustrated.

First, FIG. 16 is a case where the rear wheel maximum regenerative braking force is relatively larger than the front wheel maximum regenerative braking force, and front wheel/ rear-wheel regenerative braking force is maximally generated up to a point G, and thereafter, the front wheel braking force is increased until front wheel/rear wheel braking distribution is the same as actual braking distribution (up to a point H).

After the front wheel/rear wheel braking force distribution is the same as a basic braking distribution line, front wheel/rear wheel braking forces are simultaneously increased with the same distribution as the actual braking distribution.

Further, in the implementation example of FIG. 17, the front wheel maximum regenerative braking force is relatively larger than the rear wheel maximum regenerative braking force, and the front wheel/ rear-wheel regenerative braking force is maximally generated up to a point I, and thereafter, the front wheel braking force is increased until front wheel/rear wheel braking distribution is the same as actual braking distribution (up to a point J).

After the front wheel/rear wheel braking force distribution is the same as a basic braking distribution line, front wheel/rear wheel braking forces are simultaneously increased with the same distribution as the actual braking distribution.

Meanwhile, in the exemplary the implementation example of the present invention, the actual braking distribution line may be implemented to be close to the braking distribution line of a curb vehicle weight or more only in some sections, and the example is illustrated in FIGS. 18 and 19.

In order to improve regenerative braking energy recovery rate, next, as illustrated in FIG. 18, braking force distribution at a section after L may be set to be close to the braking distribution line of CVW or more.

In detail, in the implementation example, as illustrated in FIG. 18, the front-wheel regenerative braking force is maximally generated, and thereafter, the front wheel/rear wheel braking force is increased to have a braking force distribution ratio of the front wheel and the rear wheel according to the basic braking distribution line. Thereafter, up to a point where the basic braking distribution line crosses an abnormal braking distribution line, the braking forces of the front wheel and the rear wheel are controlled to be distributed to approximate to the abnormal braking distribution line, and from the point where the basic braking distribution line crosses the abnormal braking distribution line, braking forces of the front wheel and the rear wheel are controlled to be distributed at a predetermined ratio according to the basic braking distribution line.

In this case, the braking distribution line is set to several straight sections at a section set to approximate to the abnormal braking distribution line or the distribution line may be set at a predetermined ratio (for example, 90%, 95%, and the like) of the braking distribution of CVW or more.

After a point (point M) meeting with the braking distribution of CVW or more, a loss of braking force under a gross vehicle weight (GVW) condition is prevented to have the same distribution as the basic braking distribution line.

The weight reference of the abnormal braking line may be set based on one-person riding or two-person riding, not the CVW.

Further, in the case where a technique capable of sensing a weight of the vehicle is combined, the braking force may be distributed along the ideal braking distribution line according to the weight of the vehicle.

Meanwhile, FIG. 18 is a case of providing only the front-wheel regenerative braking force, and as illustrated in FIG. 19, even during rear-wheel regenerative braking, the example may be configured to include an approximate area to the ideal braking distribution line in the same manner.

Next, in FIGS. 20 to 23, in order to maximize regenerative braking energy recovery rate, an example configured to set a case of exceeding the abnormal braking distribution line in some sections is illustrated.

In this case, when the size of the rear-wheel regenerative braking force is too large, possibility that a rear wheel lock is generated on a road surface with a low friction coefficient is increased, and thus the rear-wheel regenerative braking force is limited to be generated only up to a rear-wheel regenerative braking limit at a predetermined level.

For example, based on a friction coefficient on the ice, on the road surface with a friction coefficient larger than the friction coefficient on the ice, the front wheel lock is set to be generated, and on the road surface with a friction coefficient smaller than the friction coefficient on the ice, the rear wheel lock may be generated.

Referring to FIGS. 20 and 21, the front-wheel regenerative braking is maximally generated up to a point Q, rear-wheel regenerative braking force is generated at a predetermined level or less by limiting the rear-wheel regenerative braking up to a point R, and next, hydraulic braking of the front and rear wheels is generated according to a reference braking distribution ratio.

Meanwhile, FIGS. 22 and 23 are examples which are similar to the implementation example of FIG. 20, but control a rear-wheel regenerative braking amount to be generated up to a maximal value.

That is, the front-wheel regenerative braking is maximally generated (up to a point T), and the rear-wheel regenerative braking force is generated to a predetermined level or less by limiting the rear-wheel regenerative braking (up to a point U). However, in the case of forming the hydraulic braking force according to actual braking distribution, unlike forming the front-wheel hydraulic barking force, in the case of the rear wheel, the limited rear-wheel regenerative braking force is maximally generated within a range that does not exceed the basic braking distribution line.

Accordingly, the point D becomes a maximal braking force point which may be generated by the rear-wheel regenerative braking force.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling a braking force in regenerative brake cooperation control, the method comprising:
a first step of generating a regenerative braking force for at least one of a front wheel and a rear wheel up to a reference deceleration while braking; and
a second step of distributing the braking force of the front wheel and the rear wheel in accordance with a reference braking distribution ratio having a predetermined value in a braking area of the reference deceleration or more.

2. The method of claim 1, wherein in the first step the braking force of the front wheel and the rear wheel is distributed in accordance with an ideal braking distribution line.

3. The method of claim 2, wherein in the first step, the braking force distributed to the rear wheel is controlled to be generated only by a rear-wheel regenerative braking force up to a maximum rear-wheel regenerative braking force.

4. The method of claim 1, wherein the reference braking distribution ratio in the second step is set approximately to a braking distribution ratio of a basic braking distribution line.

5. The method of claim 1, wherein in the first step, the braking force of the front wheel and the rear wheel is configured to be distributed in accordance with a basic braking distribution line.

6. The method of claim 5, wherein in the first step, the braking force distributed to the front wheel is controlled to be generated only by a front-wheel regenerative braking force up to a maximum front-wheel regenerative braking force and the braking force distributed to the rear wheel is controlled to be generated only by a rear-wheel regenerative braking force.

7. The method of claim 5, wherein the reference braking distribution ratio in the second step is set approximately to the braking distribution ratio of the basic braking distribution line.

8. The method of claim 5, wherein in the first step, the braking force distributed to the front wheel is controlled to be generated by a front-wheel hydraulic braking force and the braking force distributed to the rear wheel is controlled to be generated only by a rear-wheel regenerative braking force up to a maximum rear-wheel regenerative braking force.

9. The method of claim 1, wherein in the first step, the braking force of the front wheel and the rear wheel is distributed in accordance with a ratio between a maximum front-wheel regenerative braking force and a maximum rear-wheel regenerative braking force.

10. The method of claim 9, wherein in the first step, the braking force distributed to the front wheel is controlled to be generated only by a front-wheel regenerative braking force up to the maximum front-wheel regenerative braking force and the braking force distributed to the rear wheel is controlled to be generated only by the rear-wheel regenerative braking force.

11. The method of claim 1, wherein in the first step, a front-wheel regenerative braking force is maximally generated and thereafter, a rear-wheel braking force is controlled to increase to distribute the braking force of the front wheel and the rear wheel in accordance with a basic braking distribution line.

12. The method of claim 11, wherein in the first step, when the rear-wheel braking force increases to achieve a braking force distribution ratio of the front wheel and the rear wheel in accordance with the basic braking distribution line, the first step is controlled to end and the second step is controlled to be entered.

13. The method of claim 11, wherein in the first step, when the rear-wheel braking force increases to have a braking force distribution ratio of the front wheel and the rear wheel in accordance with the basic braking distribution line, up to a point where an ideal braking distribution line and the basic distribution line cross, the braking force of the front wheel and the rear wheel is controlled to be distributed in accordance with the ideal braking distribution line and from the point where the ideal braking distribution line and the basic distribution line cross, the braking force of the front wheel and the rear wheel is controlled to be distributed at a predetermined ratio in accordance with the basic braking distribution line according to the second step.

14. The method of claim 1, wherein in the first step, a rear-wheel regenerative braking force is maximally generated and thereafter, only a front-wheel braking force is controlled to increase to distribute the braking force of the front wheel and the rear wheel in accordance with a basic braking distribution line.

15. The method of claim 14, wherein in the first step, when the front-wheel braking force increases to achieve the braking force distribution ratio of the front wheel and the rear wheel in accordance with the basic braking distribution line, the first step is controlled to end and the second step is controlled to be entered.

16. The method of claim 14, wherein in the first step, when the front-wheel braking force increases to have a braking force distribution ratio of the front wheel and the rear wheel in accordance with the basic braking distribution line, up to a point where an ideal braking distribution line and the basic distribution line cross, the braking force of the front wheel and the rear wheel is controlled to be distributed in accordance with the ideal braking distribution line and from the point where the ideal braking distribution line and the basic distribution line cross, the braking force of the front wheel and the rear wheel is controlled to be distributed at a predetermined ratio in accordance with the basic braking distribution line according to the second step.

17. The method of claim 1, wherein in the first step, only when a maximum rear-wheel regenerative braking force is larger than a maximum front-wheel regenerative braking force, the braking force of the front wheel and the rear wheel is distributed until maximum braking force of the front wheel and the rear wheel is generated in accordance with a ratio between the maximum rear-wheel regenerative braking force and the maximum front-wheel regenerative braking force and only a front-wheel hydraulic braking force is controlled to increase to distribute the braking force of the front wheel and the rear wheel in accordance with a basic braking distribution line.

18. The method of claim 1, wherein in the first step, only when a maximum front-wheel regenerative braking force is larger than a maximum rear-wheel regenerative braking force, the braking force of the front wheel and the rear wheel is distributed until maximum braking force of the front wheel and the rear wheel is generated in accordance with a ratio between the maximum rear-wheel regenerative braking force and the maximum front-wheel regenerative braking force and only a rear-wheel hydraulic braking force is controlled to increase to distribute the braking force of the front wheel and the rear wheel in accordance with a basic braking distribution line.

19. The method of claim 1, wherein in the first step, a rear-wheel regenerative braking force is maximally generated and thereafter, only the rear-wheel regenerative braking force is generated up to a rear-wheel regenerative braking limit value and only a front-wheel braking force is controlled to increase to distribute the braking force of the front wheel and the rear wheel in accordance with a basic braking distribution line.

20. The method of claim 19, wherein when the front-wheel braking force increases up to a point where an ideal braking distribution line and the basic braking distribution line cross, the first step ends and the second step is entered, in which in the second step, a hydraulic braking force of the front wheel and the rear wheel is generated at a ratio depending on the basic braking distribution line.

21. The method of claim 19, wherein when the front-wheel braking force increases up to the point where the ideal braking distribution line and the basic braking distribution line cross, the first step ends and the second step is entered, in which in the second step, the rear-wheel regenerative braking force is maximally generated in accordance with the basic braking distribution line and thereafter, the rear-wheel hydraulic braking force is generated.
